(19) United States
(12) Patent Application Publication
(10) Pub. No.: US 2025/0146571 A1
(43) Pub. Date: May 8, 2025

(54) BLOCKING MECHANISM

(71) Applicant: VALEO EMBRAYAGES, Amiens (FR)

(72) Inventor: Adrien NERRIERE, Amiens (FR)

(73) Assignee: VALEO EMBRAYAGES, Amiens (FR)

(21) Appl. No.: 18/939,125

(22) Filed: Nov. 6, 2024

(30) Foreign Application Priority Data
Nov. 7, 2023 (FR) 2312098

(51) Int. Cl. F16H 63/34

(52) U.S. Cl. CPC F16H 63/3425; F16H 63/3466

(57) ABSTRACT

A blocking mechanism includes a mobile pawl mounted with the ability to pivot between a locking position and a release position. The mobile pawl includes a cam surface, a pushing device including a cam follower able to move on the cam surface in order to move the mobile pawl from the release position to the locking position, and an actuating lever moving the pushing device and including a first notch and a second notch. A positioning member engages in the first notch in the locking position and in the second notch in the release position. The positioning member including a flexible blade including a shape folded over on itself to form a V shape.

### TECHNICAL FIELD

The present invention relates to a blocking mechanism for rotationally blocking a shaft of a drivetrain of a mobility apparatus, such as a motor vehicle, for example.

### TECHNOLOGICAL BACKGROUND

Blocking mechanisms are used, for example, as a parking brake for securing a stationary motor vehicle. In such a case, they make it possible to rotationally block a transmission shaft of the motor vehicle. Such blocking mechanisms are in particular used in motor vehicles with automatic transmission, in hybrid vehicles or electric vehicles.

Blocking mechanisms are known, in particular from document US2018/0112774, that comprise a mobile pawl equipped with a locking finger and mounted on a transmission casing with the ability to pivot between a release position and a locking position in which the locking finger is inserted into a locking recess secured for conjoint rotation with the transmission shaft that is to be blocked. The blocking mechanism further includes a pushing device translationally guided on the transmission casing and including a cam follower that collaborates with a cam surface of the pawl such that a translational movement of the pushing device causes the pawl to pivot between the release position and the locking position.

An actuating lever allows the movement of the pushing device to be actuated. The actuating lever is pivotably mounted on the transmission casing and is made to rotate, directly or indirectly, by the rotor shaft of an electric motor.

Usually, the actuating lever includes an external periphery having a first and a second angular-positioning notch. A positioning member fixed to the transmission casing includes an elastic device, for example in the form of a flexible blade, bearing against the external periphery of the actuating lever. The positioning member is configured to engage in the first angular-positioning notch when the mobile pawl is in the locking position, and in the second angular-positioning notch when the mobile pawl is in the release position.

The positioning member thus enables the position of the blocking mechanism to be maintained stably and precisely in the release position and/or in the locking position.

Such a blocking-mechanism structure does present a number of technical problems:
Firstly, the compactness needs to be improved so that the blocking mechanism may be housed in the very restricted spaces allotted in recent transmissions, in particular electric vehicle transmissions.
Secondly, the assembly needs to be simplified. In particular, the various components of the blocking mechanism may be fixed to the transmission casing along fixing axes that are not mutually parallel, thereby requiring these to be assembled in a plurality of complex operations.
Finally, these improvements to the compactness and assembly need to be obtainable while at the same time maintaining sufficient mechanical strength in the positioning member, which is subjected to the mechanical loadings that arise during the phases in which the vehicle is stationary that are enabled by the blocking mechanism.

### SUMMARY

Hereinafter, ordinal adjectives are used to distinguish between features. They do not define the position of a feature. Consequently, for example, a third feature of a product does not mean that the product has a first and/or a second feature.

One idea on which the invention is based is a blocking mechanism intended to rotationally block a shaft of a vehicle.

One idea on which the invention is based is a blocking mechanism that makes it possible to solve one or more technical problems in the prior art, for example the abovementioned problems.

The invention relates to a blocking mechanism able to be mounted in a transmission casing for rotationally blocking a shaft of a vehicle having at least one locking recess, the blocking mechanism comprising:
a mobile pawl comprising a locking finger, the mobile pawl being mounted with the ability to pivot about a pivot axis between a locking position in which the locking finger is engaged in the locking recess and a release position in which the locking finger is disengaged from said locking recess, the mobile pawl comprising a cam surface;
a pushing device including a cam follower able to move on the cam surface in order to move the mobile pawl from the release position to the locking position;
an actuating lever mounted with the ability to pivot about an axis of actuation and configured to move the pushing device, the actuating lever comprising an external periphery including a first angular-positioning notch and a second angular-positioning notch; and
a positioning member collaborating with the external periphery of the actuating lever, the positioning member including a bearing surface configured to engage in the first angular-positioning notch when the mobile pawl is in the locking position and in the second angular-positioning notch when the mobile pawl is in the release position;

the positioning member including a flexible blade applying force, directly or indirectly, to the external periphery of the actuating lever, the flexible blade comprising a shape folded over on itself to form a V shape.

According to another aspect of the invention, the invention relates to a blocking mechanism able to be mounted in a transmission casing for rotationally blocking a shaft of a vehicle having at least one locking recess, the blocking mechanism comprising:
a mobile pawl comprising a locking finger, the mobile pawl being able to be mounted on the transmission casing with the ability to pivot about a pivot axis between a locking position in which the locking finger is engaged in the locking recess and a release position in which the locking finger is disengaged from said locking recess, the mobile pawl comprising a cam surface;
a pushing device including a cam follower able to move on the cam surface in order to move the mobile pawl from the release position to the locking position;
an actuating lever being able to be mounted on the transmission casing with the ability to pivot about an axis of actuation and being configured to move the pushing device, the actuating lever comprising an external periphery including a first angular-positioning notch and a second angular-positioning notch; and
   the positioning member including a flexible blade applying force, directly or indirectly, to the external periphery of the actuating lever, the flexible blade comprising a shape folded over on itself to form a V shape.

A V shape is understood to mean that, when viewed in profile, the flexible blade has substantially the shape of an upper-case letter V, the shape of the upper-case letter V comprising two branches inclined with respect to one another by an angle of between 0° and 80°, the intersection of the two branches being pointed or radiused.

Within the meaning of the present application:
“axially” means “parallel to the axis of actuation”;
“radially” means “along an axis belonging to a plane orthogonal to the axis of actuation and intersecting this axis of actuation”;
“angularly” or “circumferentially” means “about the axis of actuation”;
the terms “external” and “internal” are used to define the relative position of a component with respect to the axis of rotation with which it is concentric; a component near to said axis is thus referred to as internal, as opposed to an external component, which is situated radially at the periphery;
two components are said to be “fixed” or “rigidly secured” when they are permanently immobilized with respect to one another, it being possible for this immobilization to be the result of the first component being fixed to the second component directly or via one or more intermediate components.

The flexible blade is a simple and economical solution that enables easy determination of a geometry that is compatible with a restricted amount of available space while at the same time providing enough mechanical strength and stiffness to hold the blocking mechanism in position.

The V shape makes it possible to obtain, in a restricted available volume, a flexible blade that has a very long flexing part. By comparison with flexible blades of the prior art that have a flat or slightly bent flexing part, the V-shaped blade may make it possible to obtain equivalent mechanical strength and stiffness in a smaller bulk, typically with a 20 to 60% reduction in circumferential bulk.

According to an additional feature of the invention, the V shape comprises a first planar wall and a second planar wall, a bending angle being established between the first planar wall and the second planar wall, the bending angle being between 0° and 80°, the bending angle preferably being between 0° and 40°.

The bending angle according to this last feature makes it possible to minimize the radial bulk of the flexible blade. The magnitude chosen for the angle also makes it possible to adjust the magnitude of the force that the flexible blade applies to the external periphery of the actuating lever.

According to an additional feature of the invention, a curved wall connects the first planar wall and the second planar wall.

According to an additional feature of the invention, the curved wall has a radius of curvature of between 2 mm and 10 mm.

According to an additional feature of the invention, a radius of curvature of the curved wall, a thickness of the flexible blade and a ratio of the radius of curvature to the thickness of the flexible blade are established, the ratio being between 2 and 8.

The curved wall as defined according to these last three features allows the stiffness of the flexible blade to be adapted while at the same time limiting the mechanical stress concentrations in said blade.

According to an additional feature of the invention, the first planar wall and the second planar wall are parallel to the axis of actuation.

According to an additional feature of the invention, the positioning member includes a rolling element arranged on the flexible blade, the rolling element being configured to roll along the external periphery of the actuating lever.

The rolling element makes it possible to improve the durability of the blocking mechanism by limiting wear and friction between the external periphery of the actuating lever and the flexible blade.

Advantageously, the rolling element may be a cylindrical roller. A complementary shape may then be formed on the end of the flexible blade in order to establish a pivot connection between the cylindrical roller and the flexible blade.

According to an additional feature of the invention, the flexible blade comprises a first bent fixing tab and a second bent fixing tab, the first and second bent fixing tabs being bent at an angle of 90° from a first portion of the flexible blade and positioned axially one on each side of said first portion of the flexible blade.

By virtue of this last feature, the flexible blade has a fixing zone on each side of its flexing part, and this has the effect of evenly distributing the absorption of forces in the flexible blade and thus of reducing the mechanical stress in said blade.

According to an additional feature of the invention, the first bent fixing tab is bent in an opposite direction to the second bent fixing tab.

This last feature makes it possible for the first bent fixing tab not to axially face the second bent fixing tab. Thus, the first bent fixing tab does not impede the passage of a fixing tool for accessing the second bent fixing tab, and vice versa. Access to the first and second bent fixing tabs for fixing the positioning member is thereby simplified.

According to an additional feature of the invention, the first bent fixing tab and the second bent fixing tab are axially offset with respect to one another in a direction parallel to the axis of actuation.

By virtue of this architecture, the actuating lever and the positioning member are assembled along parallel axes. They may therefore easily be mounted together during the same assembly operation. The axial offsetting of the first bent fixing tab with respect to the second bent fixing tab simplifies the assembly of the positioning member in that this is performed sequentially, a first stage involving pre-positioning via the first bent fixing tab, the first bent fixing tab having, for example, a hole for fitting onto a centring pin that is fixed to the transmission casing, then a second stage involving complete immobilization via the second bent fixing tab, for example by means of a screw connecting the second bent fixing tab to the transmission casing.

According to an additional feature of the invention, the blocking mechanism comprises:
a first fixing means, in particular a centring pin, collaborating with the first bent fixing tab in order to block the movement of the positioning member in a plane perpendicular to the axis of actuation; and
a second fixing means, in particular a screw, collaborating with the second bent fixing tab in order to block the movement of the positioning member along an axis parallel to the axis of actuation.

The positioning member may be fixed in accordance with this last feature with respect to any type of component on which the blocking mechanism may be mounted, in particular the transmission casing.

Thus, the fixing of the positioning member is statically determinate. In other words, all of the degrees of freedom of movement of the positioning member are blocked, while at the same time ensuring easy assembly without the risk of components being deformed.

According to an additional feature of the invention, the bent fixing tab includes a first cutout, which is preferably circular and is configured to be centred and fitted on a centring pin, a first diametral clearance being defined between the circular cutout and the centring pin, the first diametral clearance preferably being between 0.05 and 0.2 mm.

According to an additional feature of the invention, the second bent fixing tab includes a second cutout, which is preferably circular and is configured to collaborate with the body of a screw, a second diametral clearance being defined between the second cutout and the body of the screw, the second diametral clearance being greater than the first diametral clearance, the second diametral clearance preferably being greater than 0.5 mm.

By virtue of this last feature, the risk of assembly being impossible on account of the manufacturing tolerances of the components is eliminated.

According to an additional feature of the invention, the positioning member is fixed to the transmission casing.

According to an additional feature of the invention, the actuating lever is pivotably mounted on the transmission casing.

According to an additional feature of the invention, the mobile pawl is pivotably mounted on the transmission casing.

According to an additional feature of the invention, the transmission casing includes bearing surfaces positioned, through form fitting, facing the first and second bent fixing tabs of the positioning member.

According to an additional feature of the invention, the flexible blade has a shape configured to leave a passage unobstructed along an axis parallel to the axis of actuation, which allows assembly of the first and second fixing means.

This last feature makes it possible to define the overall shape of the flexible blade such that no part thereof impedes the passage of a fixing tool. Access to the first and second bent fixing tabs for fixing the positioning member is thereby simplified.

According to an additional feature of the invention, the axis of actuation of the actuating lever is parallel to the pivot axis of the mobile pawl.

By virtue of this feature, the assembly may be simplified even further because all of the components of the blocking mechanism that are mounted on the transmission casing may be mounted along parallel axes; they may therefore all be mounted during the same assembly operation.

According to an additional feature of the invention, the external periphery of the actuating lever is made up of surfaces parallel to the axis of actuation.

According to an additional feature of the invention, the actuating lever is formed from a plate cut from a sheet of constant thickness, the external periphery of the actuating lever being obtained from a cut edge face of the plate.

Thus, the actuating lever may be produced using a simple and economical manufacturing process.

According to an additional feature of the invention, the flexible blade is elastically and/or radially deformed as it moves over the external periphery of the actuating lever.

According to an additional feature of the invention, the flexible blade is formed as a single piece from a strip of metal material, in particular from sheet steel.

Thus, the manufacturing process is simple and economical: starting from a sheet of constant thickness, typically of between 0.5 and 2 mm, a cutting-out operation, for example a press-cutting operation, is performed in order to cut out the exterior and interior contours of the flexible blade, followed by a bending operation in order to give it the V shape.

According to an additional feature of the invention, the flexible blade is manufactured from a metal that has undergone a hardening treatment, in particular carbonitriding, nitriding, case-hardening or quench-hardening.

This feature makes it possible to increase the mechanical strength of the flexible blade required to withstand the mechanical loadings transmitted to the blocking mechanism.

According to an additional feature of the invention, the flexible blade has a stiffness of between 10 and 50 N/mm.

According to an additional feature of the invention, the flexible blade moves radially when the positioning member collaborates with the external periphery of the actuating lever, the radial movement varying between 1 and 10 mm irrespective of the angular position of the actuating lever.

According to an additional feature of the invention, the actuating lever is made to rotate, directly or indirectly, by a rotor shaft of an electric motor.

According to another of its aspects, the invention relates to a transmission system comprising a shaft having at least one locking recess and a blocking mechanism as described above.

The invention also relates to a motor vehicle comprising a transmission system as defined above.

### BRIEF DESCRIPTION OF THE FIGURES

FIG. 1 is a face-on view of a blocking mechanism according to one embodiment of the invention.

FIG. 2 is a perspective view of FIG. 1.

FIG. 3 is a perspective view of part of the blocking mechanism according to one embodiment of the invention.

FIG. 4 is a top view of FIG. 3.

FIG. 5 is a perspective view of a positioning member according to one embodiment of the invention.

FIG. 6 is a face-on view of FIG. 5.

FIG. 7 is a perspective view of an actuating lever according to one embodiment of the invention.

### DESCRIPTION OF THE EMBODIMENTS

Throughout the figures, elements that are identical or perform the same function bear the same reference numbers. The following embodiments are examples. Although the description refers to one or more embodiments, this does not necessarily mean that each reference relates to the same embodiment, or that the features apply only to one embodiment. Individual features of various embodiments may also be combined or interchanged in order to create other embodiments.

A mechanism for rotationally blocking a shaft of a vehicle comprises in particular: a mobile pawl, a pushing device, an actuating lever and a positioning member. The blocking mechanism is in particular intended to immobilize a vehicle, for example a car, when parked. The various elements of an embodiment of the blocking mechanism are set out below.

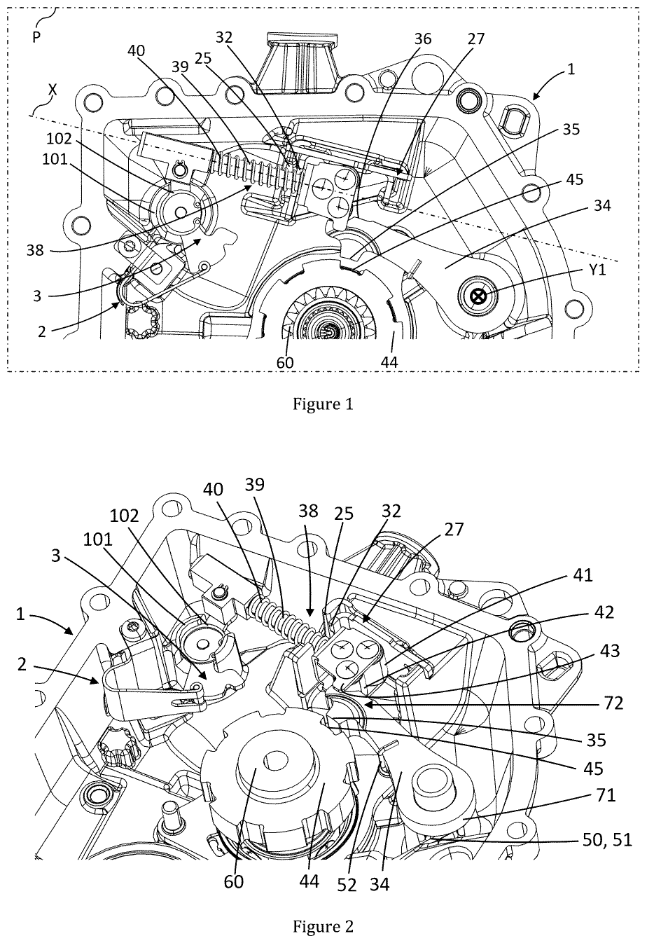

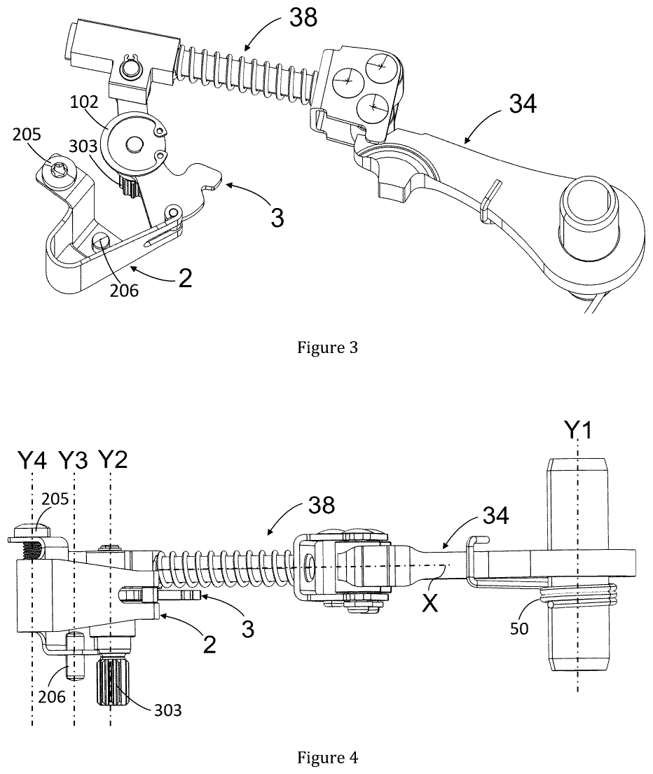

FIGS. 1 and 2 illustrate a blocking mechanism according to one embodiment of the invention. In these figures, the blocking mechanism comprises a mobile pawl 34 situated in a transmission casing 1 (partially depicted). The mobile pawl 34 may have an elongate shape and may have a first end 71 and a second end 72 at a distance from the first end 71.

The first end 71 enables, for example, the mobile pawl 34 to be fixed to the transmission casing 1 while at the same time allowing said mobile pawl 34 to move in rotation. In other words, the mobile pawl is mounted with the ability to pivot in a plane P about a pivot axis Y1.

The second end 72 may comprise a cam surface 36 situated on a first lateral face of the mobile pawl 34. The second end 72 may further comprise a locking finger 35 projecting from a second lateral face of the mobile pawl 34. The locking finger 35 is intended, when the blocking mechanism is triggered, to be inserted into a locking recess 45. The locking recess 45 is for example situated on a ratchet wheel 44 that is able to receive said locking finger 35 and that is secured for conjoint rotation with the transmission shaft 60 (partially depicted) intended to be rotationally blocked.

Thus, the blocking mechanism varies between a locking position in which the locking finger 35 is engaged in the locking recess 45 and a release position in which the locking finger 35 is disengaged from said locking recess 45. In FIGS. 1 and 2, the mechanism for rotationally blocking a shaft is depicted in a release position.

The mobile pawl 34 may further comprise a torsion spring 50. The torsion spring 50 is for example wound at the first end 71 of the mobile pawl 34. The torsion spring 50 may comprise a first end 51, which bears against a bearing surface of the transmission casing 1, and a second end 52, which bears against a bearing surface of the mobile pawl 34. The torsion spring 50 is arranged so as to apply a return force to the mobile pawl 34 in order to return the latter to the release position.

The blocking mechanism further comprises a pushing device 38. The pushing device 38 may be guided in a longitudinal direction X by a guide rail 27 housed in the transmission casing 1. In the cases in which the pushing device 38 is pushed back by the mobile pawl 34 in dynamic phases, the pushing device 38 may come into abutment against a lateral wall of the guide rail 27, which thus forms a non-return stop for the pushing device 38. The pushing device 38 is in this case pushed against the mobile pawl 34 by a return force applied by a traction spring 40. This effect may for example be produced when engagement is attempted at excessively high speed. Beyond a threshold speed, for example between 3 km/h and 5 km/h, the mobile pawl 34 springs back so as to prevent engagement, and the pushing device 38 is thus pushed back into abutment. The spring 40 surrounds a rod 39 of the pushing device, which extends through a first notch 25 in the transmission casing 1 and a second notch 32 in the guide rail 27.

The pushing device 38 may take the form of a mobile carriage that for example comprises a first mobile roller 41 that is able to move along a longitudinal wall 30 of the guide rail 27. The pushing device 38 may further comprise a cam follower 42 including a second mobile roller that is in contact with the cam surface 36 of the mobile pawl 34 and able to move along this cam surface 36.

The pushing device 38 may further comprise a lug 43 situated at the second end of the mobile pawl 34. The lug 43 is intended to keep the mobile pawl 34 in the plane P.

In order to move the mobile pawl 34 into the locking position, the rod 39 may be moved through the second notch 32 in the guide rail 27, thus moving the pushing device 38 in the longitudinal direction X. The movement of the pushing device 38 may cause the first mobile roller 41 to move along the guide rail 27 and the cam follower 42 to move along the cam surface 36 of the mobile pawl 34. The cam surface 36 may have a slope and the movement of the pushing device 38 may thus apply pressure towards the cam surface 36 of the mobile pawl 34. This pressure may cause the second end of the mobile pawl 34 to move in rotation towards a locking recess in such a way that the locking finger 35 may engage in a locking recess present for example on a ratchet wheel 44.

FIGS. 3 to 7 more particularly illustrate an actuating lever 3 and a positioning member 2 of the blocking mechanism according to one embodiment of the invention.

The actuating lever 3 is mounted on the transmission casing 1 with the ability to pivot about an axis of actuation Y2. A housing 101 (shown in FIG. 2) formed in the transmission casing 1 may collaborate with a retaining ring 102 in order to block the actuating lever 3 axially. The actuating lever 3 may be made to rotate by a drive shaft 303, the drive shaft 303 collaborating in terms of rotation with a rotor shaft of an electric motor, in particular via gearing enabling a speed reduction to be achieved. The actuating lever 3 may be connected to the rod 39, for example via a pivot connection, so that a rotation of the actuating lever 3 about the axis of actuation Y2 causes the pushing device 38 to move in translation in the longitudinal direction X.

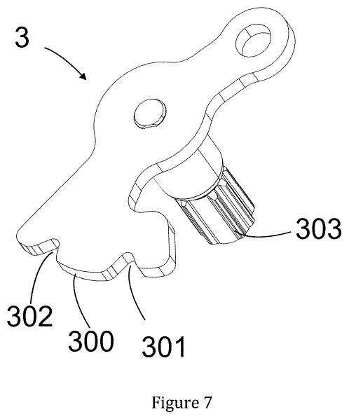

As illustrated in FIG. 7, the actuating lever 3 further comprises an external periphery 300 including a first angular-positioning notch 301 and a second angular-positioning notch 302. The actuating lever 3 may be formed from a plate cut from a sheet of constant thickness, for example a thickness of between 3 and 6 mm, the external periphery 300 being obtained from a cut edge face of the plate.

As illustrated by FIGS. 3 and 5, the positioning member 2 collaborates with the external periphery of the actuating lever 3, the positioning member 2 includes a bearing surface 204 configured to engage in the first angular-positioning notch 301 when the mobile pawl 34 is in the locking position and in the second angular-positioning notch 302 when the mobile pawl 34 is in the release position. The positioning member 2 thus enables the position of the blocking mechanism to be maintained stably and precisely in the release position and/or in the locking position.

In this embodiment, the positioning member 2 includes a flexible blade 200 applying force, directly or indirectly, to the external periphery 300 of the actuating lever 3. A rolling element 203, for example a cylindrical roller, arranged on the flexible blade 200 may be configured to roll along the external periphery 300 of the actuating lever 3.

The positioning member 2 may be fixed to the transmission casing 1 via a first bent fixing tab 201 and via a second bent fixing tab 202 of the flexible blade 200, it being possible for the first bent fixing tab 201 and the second bent fixing tab 202 to be offset with respect to one another in a direction parallel to the axis of actuation Y2. Advantageously, the first bent fixing tab 201 and the second bent fixing tab 202 may be bent at an angle of 90° from a first portion 210 of the flexible blade 200 and positioned axially one on each side of said first portion 210 of the flexible blade 200. The first bent fixing tab 201 may be bent in an opposite direction to the second bent fixing tab 202.

As illustrated in FIGS. 3 and 4, a first fixing means 206, in this instance a centring pin, may collaborate with a circular hole in the first bent fixing tab 201 in order to limit the movement of the positioning member 2 with respect to the transmission casing 1 in the plane P perpendicular to the axis of actuation Y2. Advantageously, a very small first diametral clearance, typically of between 0.05 mm and 0.2 mm, is formed between the circular hole and the centring pin. A second fixing means 205, in this instance a screw, may collaborate with the second bent fixing tab 202 in order to block the movement of the positioning member 2 with respect to the transmission casing 1 along a fourth axis Y4 parallel to the axis of actuation Y2.

As illustrated in FIG. 4, four axes may be defined for assembling on the transmission casing 1: the axis of actuation Y2 of the actuating lever 3, the pivot axis Y1 of the mobile pawl 34, the fourth axis Y4 along which the screw 205 may be assembled, and a third axis Y3 along which the centring pin 206 may be assembled. Advantageously, these four axes may be parallel, thereby enabling all of these components to be mounted easily during the same assembly operation.

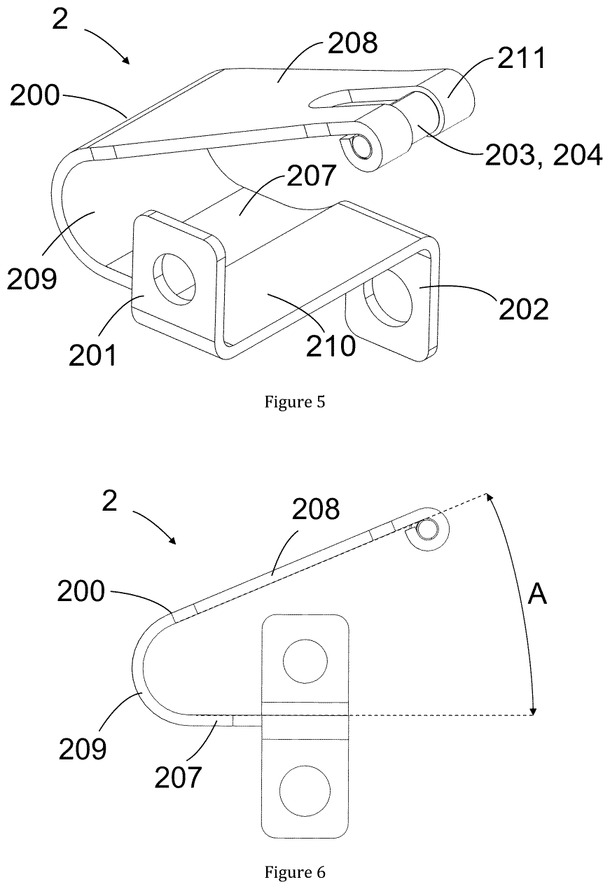

As illustrated in FIGS. 5 and 6, the flexible blade 200 comprises a shape folded over on itself to form a V shape. The V shape may comprise a first planar wall 207 and a second planar wall 208, a bending angle A being established between the first planar wall 207 and the second planar wall 208, the bending angle A preferably being between 0° and 40°, and being 30° in the example in FIG. 6. A curved wall 209 may connect the first planar wall 207 and the second planar wall 208, the curved wall 209 having a radius of curvature of between 2 mm and 10 mm, and of 6.5 mm in the example in FIG. 6. Advantageously, the radius of curvature of the curved wall 209 may be chosen according to the thickness of the flexible blade 200 so as to improve the trade-off between the stiffness thereof and the mechanical stress thereon. A ratio of the radius of curvature to the thickness of the flexible blade 200 may be established, the ratio preferably being between 2 and 8. In the example in FIG. 6, the thickness of the flexible blade 200 is 1.5 mm and the ratio is therefore 4.3.

The flexible blade 200 may be formed as a single piece from a strip of metal material. In the example in FIG. 6, the flexible blade 200 is produced from a piece of steel strip, which is press-cut in order to obtain its contours, then bent to obtain its V shape, the first and second bent fixing tabs 201 and 202, and also an additional shape 211 that makes it possible to establish a pivot connection between the cylindrical roller 203 and the flexible blade 200. The flexible blade 200 may then undergo a hardening treatment in order to improve its mechanical integrity.

The first planar wall 207 and the second planar wall 208 of the flexible blade 200 may be parallel to the axis of actuation Y2. In addition, the shape of the flexible blade 200, in particular its V shape and/or the magnitude of the bending angle A chosen, may be chosen in such a way as to leave a passage unobstructed, which allows assembly of the second fixing means 205 along the fourth axis Y4 and of the first fixing means 206 along the third axis Y3.

It should be noted that all of the features, as they appear to a person skilled in the art on the basis of the present description, the drawings and the accompanying claims, even if in practice they have been described only in relation to other specific features, both individually and in any combination, may be combined with other features or groups of features disclosed herein, provided that this has not been expressly excluded or that technical circumstances make such combinations impossible or meaningless.

Use of the verbs “include” or “comprise” and their conjugated forms does not exclude the presence of elements or steps other than those described in a claim.

In the claims, any reference sign between parentheses should not be interpreted as limiting the claim.

1. Blocking mechanism able to be mounted in a transmission casing for rotationally blocking a shaft of a vehicle having at least one locking recess, the blocking mechanism comprising:
a mobile pawl comprising a locking finger, the mobile pawl being mounted with the ability to pivot about a pivot axis between a locking position in which the locking finger is engaged in the locking recess and a release position in which the locking finger is disengaged from said locking recess, the mobile pawl comprising a cam surface;
a pushing device including a cam follower able to move on the cam surface in order to move the mobile pawl from the release position to the locking position;
an actuating lever mounted with the ability to pivot about an axis of actuation and configured to move the pushing device, the actuating lever comprising an external periphery including a first angular-positioning notch and a second angular-positioning notch; and
a positioning member collaborating with the external periphery of the actuating lever, the positioning member including a bearing surface configured to engage in the first angular-positioning notch when the mobile pawl is in the locking position and in the second angular-positioning notch when the mobile pawl is in the release position;
wherein the positioning member includes a flexible blade applying force, directly or indirectly, to the external periphery of the actuating lever, the flexible blade comprising a shape folded over on itself to form a V shape.

2. Blocking mechanism according to claim 1, wherein the V shape comprises a first planar wall and a second planar wall, a bending angle being established between the first planar wall and the second planar wall, the bending angle being between 0° and 80°, the bending angle preferably being between 0° and 40°.

3. Blocking mechanism according to claim 2, wherein a curved wall connects the first planar wall and the second planar wall.

4. Blocking mechanism according to claim 3, wherein the curved wall has a radius of curvature of between 2 mm and 10 mm.

5. Blocking mechanism according to claim 3, wherein a radius of curvature of the curved wall, a thickness of the flexible blade and a ratio of the radius of curvature to the thickness of the flexible blade are established, the ratio being between 2 and 8.

6. Blocking mechanism according to claim 2, wherein the first planar wall and the second planar wall are parallel to the axis of actuation.

7. Blocking mechanism according to claim 1, wherein the positioning member includes a rolling element arranged on the flexible blade, the rolling element being configured to roll along the external periphery of the actuating lever.

8. Blocking mechanism according to claim 1, wherein the flexible blade comprises a first bent fixing tab and a second bent fixing tab, the first and second bent fixing tabs being bent at an angle of 90° from a first portion of the flexible blade and positioned axially one on each side of said first portion of the flexible blade.

9. Blocking mechanism according to claim 8, wherein the first bent fixing tab is bent in an opposite direction to the second bent fixing tab.

10. Blocking mechanism according to claim 8, wherein the first bent fixing tab and the second bent fixing tab are axially offset with respect to one another in a direction parallel to the axis of actuation.

11. Blocking mechanism according to claim 8, wherein:
a first fixing means, in particular a centring pin, collaborates with the first bent fixing tab in order to limit the movement of the positioning member in a plane perpendicular to the axis of actuation; and
a second fixing means, in particular a screw, collaborates with the second bent fixing tab in order to block the movement of the positioning member along an axis parallel to the axis of actuation.

12. Blocking mechanism according to claim 11, wherein the flexible blade has a shape configured to leave a passage unobstructed along an axis parallel to the axis of actuation, which allows assembly of the first and second fixing means.

13. Blocking mechanism according to claim 1, wherein the external periphery of the actuating lever is made up of surfaces parallel to the axis of actuation.

14. Blocking mechanism according to claim 1, wherein the flexible blade is formed as a single piece from a strip of metal material, in particular from sheet steel.

15. Transmission system comprising a shaft having at least one locking recess and a blocking mechanism according to claim 1.

16. Blocking mechanism according to claim 4, wherein a radius of curvature of the curved wall, a thickness of the flexible blade and a ratio of the radius of curvature to the thickness of the flexible blade are established, the ratio being between 2 and 8.

17. Blocking mechanism according to claim 4, wherein the first planar wall and the second planar wall are parallel to the axis of actuation.

18. Blocking mechanism according to claim 2, wherein the positioning member includes a rolling element arranged on the flexible blade, the rolling element being configured to roll along the external periphery of the actuating lever.

19. Blocking mechanism according to claim 2, wherein the flexible blade comprises a first bent fixing tab and a second bent fixing tab, the first and second bent fixing tabs being bent at an angle of 90° from a first portion of the flexible blade and positioned axially one on each side of said first portion of the flexible blade.

20. Blocking mechanism according to claim 9, wherein the first bent fixing tab and the second bent fixing tab are axially offset with respect to one another in a direction parallel to the axis of actuation.
